(19) United States
(12) Patent Application Publication
(10) Pub. No.: US 2013/0238104 A1
(43) Pub. Date: Sep. 12, 2013

(54) SYSTEM DESIGN DEVICE

(71) Applicants: Akira Fujisawa, Chiyoda-ku (JP); Tomofumi Ishihara, Chiyoda-ku (JP); Hiroyuki Nakata, Chiyoda-ku (JP); Masayuki Ueno, Chiyoda-ku (JP)

(72) Inventors: Akira Fujisawa, Chiyoda-ku (JP); Tomofumi Ishihara, Chiyoda-ku (JP); Hiroyuki Nakata, Chiyoda-ku (JP); Masayuki Ueno, Chiyoda-ku (JP)

(73) Assignee: MITSUBISHI ELECTRIC CORPORATION, Tokyo (JP)

(21) Appl. No.: 13/885,837

(22) PCT Filed: Nov. 24, 2010
(86) PCT No.: PCT/JP2010/070926

§ 371 Date: May 16, 2013

(51) Int. Cl. G05B 15/02

(52) U.S. Cl. CPC G05B 15/02
USPC 700/83

(57) ABSTRACT

A system design device includes: a storage unit that stores therein configuration diagrams of FA devices designed by the device itself as design-target-unit configuration diagrams and stores therein configuration diagrams of a plurality of FA devices that are not designed by the device itself as a general-purpose-unit configuration diagram that is one configuration diagram; an input unit that has input thereto command information for specifying at least one of the design-target-unit configuration diagrams and the general-purpose-unit configuration diagram; a system-configuration-diagram creation unit that reads a design-target-unit configuration diagram and a general-purpose-unit configuration diagram from the storage unit according to command information input from the input unit and creates a system configuration diagram of the FA system; and a display unit that displays a system configuration diagram created by the system-configuration-diagram creation unit, thereby displaying the plurality of FA devices as a general-purpose-unit configuration diagram that is one configuration diagram.

### FIELD

The present invention relates to an FA system design device that designs a system constituted by FA devices.

### BACKGROUND

A system constituted by factory-automation (FA) devices such as a programmable logic controller (PLC) and a display is designed and established by device manufacturers of the FA devices. Because the FA system is constituted by combining units (the FA devices) having various features, a design range is allocated to each of the device manufacturers when the system development is performed. Each of the device manufacturers uses a system design device to create a system configuration diagram (design the system) within its allocated design range.

For example, in a case where the system is designed on a large scale by a plurality of device manufacturers, an operator of the system design device (hereinafter, “designer”) from each of the device manufacturers shows design ranges allocated to the other device manufacturers (hereinafter, “system outside of allocated design range”) as a general-purpose unit in the system configuration diagram. When there are a plurality of the systems outside of the allocated design range, general-purpose units are created in the system configuration diagram by the number of the systems outside of the allocated design range.

Similarly, the designer shows a device that is not supported by the system design device as a general-purpose unit in the system configuration diagram. In a case where there are a plurality of the devices that are not supported by the system design device, general-purpose units are created in the system configuration diagram by the number of the devices that are not supported by the system design device.

Therefore, as the number of the systems outside of the allocated design range and the number of the devices that are not supported by the system design device are larger, an increased burden is imposed on the designer at the time of designing the system. To reduce the burden imposed on the designer at the time of designing the system, there is a technique to represent a plurality of functions as one virtual unit (see, for example, Patent Literature 1).

### CITATION LIST

### Patent Literature

Patent Literature 1: Japanese Patent Application Laid-open No. 2008-146385

### SUMMARY

### Technical Problem

However, in the above conventional technique, in a case where a system is designed by many device manufacturers, each designer of the device manufacturers has to create many general-purpose units in a system configuration diagram. Further, in a case where there are many devices that are not supported by a system design device in the system, the designer has to create many general-purpose units in the system configuration diagram. As described above, when the system is designed on a large scale, many general-purpose units have to be created in the system configuration diagram. Therefore, there is a problem that much time and effort is required to create the system configuration diagram.

The present invention has been achieved to solve the above problems, and an object of the present invention is to provide a system design device that can easily create a system configuration diagram.

### Solution to Problem

In order to solve the above problem and in order to attain the above object, a system design device of the present invention includes: a storage unit that stores therein configuration diagrams of FA devices designed by the device itself among FA devices that are constituent elements of an FA system as design-target-unit configuration diagrams and stores therein configuration diagrams of a plurality of FA devices that are not designed by the device itself among the FA devices as a general-purpose-unit configuration diagram that is one configuration diagram; an input unit that has input thereto command information for specifying at least one of the design-target-unit configuration diagrams and the general-purpose-unit configuration diagram; a system-configuration-diagram creation unit that reads a design-target-unit configuration diagram and a general-purpose-unit configuration diagram from the storage unit according to command information input from the input unit and creates a system configuration diagram of the FA system; and a display unit that displays a system configuration diagram created by the system-configuration-diagram creation unit, thereby displaying a plurality of FA devices that are not designed by the device itself among the FA devices as a general-purpose-unit configuration diagram that is one configuration diagram.

### Advantageous Effects of Invention

The system design device according to the present invention can easily create a system configuration diagram.

### BRIEF DESCRIPTION OF DRAWINGS

FIG. 1 depicts a hardware configuration of a system design device according to a first embodiment of the present invention.

FIG. 2 is a functional block diagram of the system design device according to the first embodiment.

FIG. 3 depicts a configuration of general-purpose unit information.

FIG. 4 depicts a configuration of a screen displayed on a display device of the system design device according to the first embodiment.

FIG. 5 is a flowchart of an operation process procedure in the system design device.

FIG. 6 is a configuration example of an FA system.

FIG. 7 is an example of a screen displayed on the display device.

FIG. 8 is a functional block diagram of a system design device according to a second embodiment.

FIG. 9 depicts a configuration of a screen displayed on a display device of the system design device according to the second embodiment.

FIG. 10 is a flowchart of a parameter-setting process procedure.

FIG. 11 is an example of a parameter setting screen.

FIG. 12 is an example of a parameter setting screen in a case where parameters are station numbers.

FIG. 13 is a flowchart of a link-file-setting process procedure.

FIG. 14 is an example of a link-file setting screen.

### DESCRIPTION OF EMBODIMENTS

Exemplary embodiments of a system design device according to the present invention will be explained below in detail with reference to the accompanying drawings. The present invention is not limited to the embodiments.

### First Embodiment

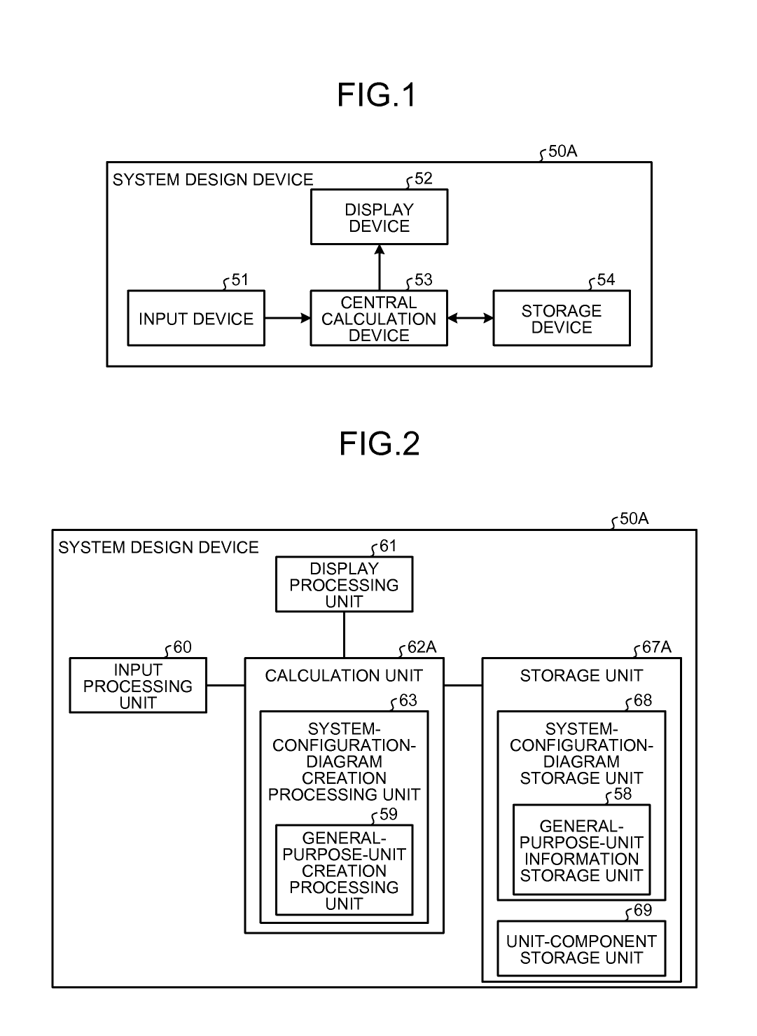

FIG. 1 depicts a hardware configuration of a system design device according to a first embodiment of the present invention. A system design device 50A is a computer or the like that creates a system configuration diagram of an FA system constituted by FA devices such as a PLC and a display and that designs the FA system. The system design device 50A starts software (a system design program) having been installed therein in advance, thereby creating the system configuration diagram.

In the system design device 50A according to the present embodiment, an FA device outside of the allocated design range and an FA device in which its design is not supported by the system design device 50A are represented as one general-purpose unit (hereinafter, “integrated general-purpose unit”) in the system configuration diagram.

The system design device 50A includes an input device 51 including a keyboard, a mouse, and the like, a display device 52 such as a liquid crystal monitor, a central calculation device 53, and a storage device 54. In the system design device 50A, the input device 51 and the display device 52 are connected to the central calculation device 53 and the storage device 54 through a bus line.

The central calculation device 53 is an information processing device such as a central processing unit (CPU). The storage device 54 is a device such as a read only memory (ROM), a random access memory (RAM), and the like.

The central calculation device 53 uses the system design program that is a computer program to create a system configuration diagram. The display device 52 displays the system configuration diagram and the like on a display screen based on a command from the central calculation device 53. For example, the display device 52 displays a unit component (the FA device) and the integrated general-purpose unit that are incorporated in the FA system on the display screen as the system configuration diagram.

The input device 51 inputs command information input by a designer (a user of the system design device 50A). Command information for specifying a type of the FA device to be designed by the system design device 50A, command information for displaying the integrated general-purpose unit on the system configuration diagram, and the like are input to the input device 51. The command information input to the input device 51 is transmitted to the central calculation device 53.

The system design program is held in the ROM in the storage device 54 and loaded into the RAM in the storage device 54 through a bus line. The central calculation device 53 executes the system design program loaded into the RAM. Specifically, in the system design device 50A, according to a command input from the input device 51 by the user, the central calculation device 53 reads the system design program from the ROM and develops it in a program holding area in the RAM to perform various processing. The central calculation device 53 temporarily stores various data generated by the various processing in a data holding area formed in the RAM.

The system design program executed by the system design device 50A has a module configuration including a system-configuration-diagram creation processing unit 63 that is described later. These modules are loaded on a main storage device and generated on the main storage device.

FIG. 2 is a functional block diagram of the system design device according to the first embodiment. FIG. 2 depicts a functional block diagram of the system design device 50A achieved by using the central calculation device 53 and the storage device 54 that are shown in FIG. 1. Therefore, the input device 51 and the display device 52 are not shown in FIG. 2.

The system design device 50A includes an input processing unit 60, a display processing unit 61, a calculation unit 62A, and a storage unit 67A. The input processing unit 60 performs processing for inputting information, transmitted from the input device 51, to the calculation unit 62A. The display processing unit 61 creates display data to be output to the display device 52. The display processing unit 61 creates display data based on a calculation result calculated by the calculation unit 62A (a system configuration diagram and the like), and outputs the display data to the display device 52.

The calculation unit 62A performs a function of creating a system configuration diagram. The calculation unit 62A includes the system-configuration-diagram creation processing unit 63. The system-configuration-diagram creation processing unit 63 includes a general-purpose-unit creation processing unit 59.

The system-configuration-diagram creation processing unit 63 performs processing for creating a system configuration diagram to be displayed on the display device 52. The system-configuration-diagram creation processing unit 63 also performs processing for creating information concerning the system configuration diagram.

The general-purpose-unit creation processing unit 59 performs processing for creating an integrated general-purpose unit to be displayed on a system-configuration-diagram display unit 73. The general-purpose-unit creation processing unit 59 also performs processing for creating information concerning the integrated general-purpose unit.

The system-configuration-diagram creation processing unit 63 has a drawing function of graphically drawing an FA system configuration on a screen and a unit arrangement function of arranging a unit component selected from a list on the screen at the time of drawing the FA system configuration. The system-configuration-diagram creation processing unit 63 according to the present embodiment uses an FA device that is a design target and specified by the designer (design-target-unit configuration diagram) and the integrated general-purpose unit specified by the designer (general-purpose-unit configuration diagram) to create a system configuration diagram.

The general-purpose-unit creation processing unit 59 performs various information settings such that the integrated general-purpose unit arranged on the system configuration diagram can represent a plurality of units. The system-configuration-diagram creation processing unit 63 stores the created system configuration diagram in a system-configuration-diagram storage unit 68.

The storage unit 67A stores therein the system configuration diagram, a configuration diagram of a unit component, and the like that are created by using the calculation unit 62A. The storage unit 67A includes the system-configuration-diagram storage unit 68 and a unit-component storage unit 69. The system-configuration-diagram storage unit 68 includes a general-purpose-unit information storage unit 58.

The system-configuration-diagram storage unit 68 stores therein the system configuration diagram created by using the calculation unit 62A. The unit-component storage unit 69 stores therein diagrams representing an FA device in which its design is supported by the system design device 50A, a network cable, and the like and diagrams representing the integrated general-purpose unit and the like as unit component diagrams related to unit components. In other words, the unit-component storage unit 69 stores therein a configuration diagram of an FA device designed by the device itself (the system design device 50A) (design-target-unit configuration diagram) and a configuration diagram of a plurality of FA devices that are not designed by the device itself (one general-purpose-unit configuration diagram).

The unit component diagrams stored in the unit-component storage unit 69 are used when the calculation unit 62A creates a system configuration diagram. The designer selects a unit component diagram needed to create the system configuration diagram (a unit component diagram within the allocated design range) from the unit component diagrams stored in the unit-component storage unit 69 and uses the selected unit component diagram to create the system configuration diagram. The general-purpose-unit information storage unit 58 stores therein general-purpose unit information that is information concerning the integrated general-purpose unit.

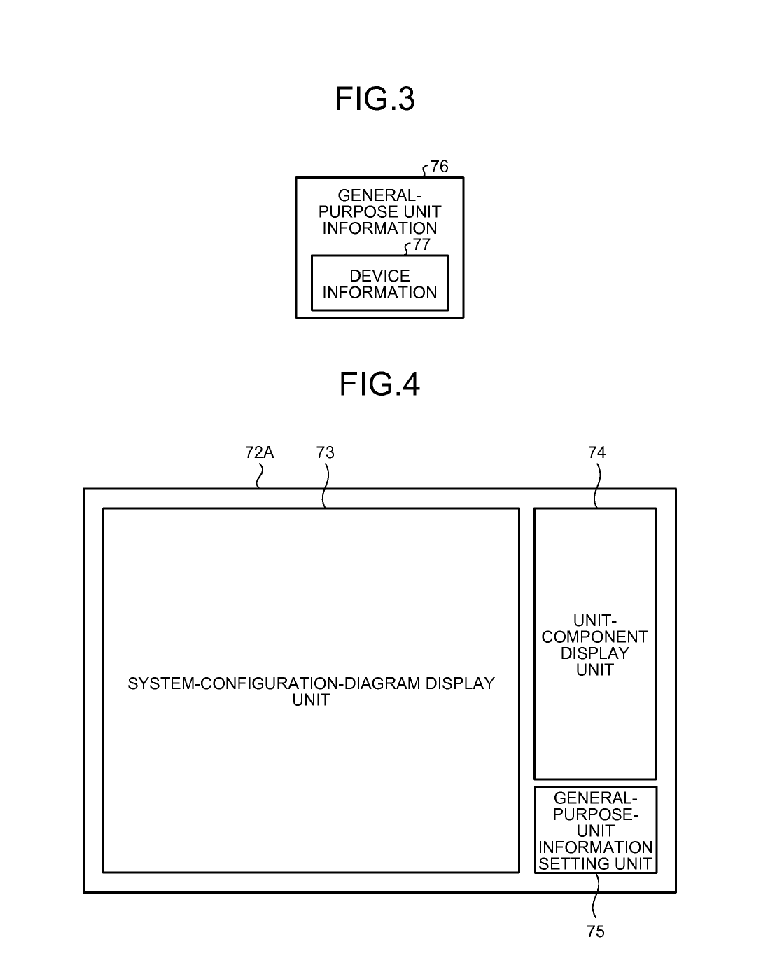

FIG. 3 depicts a configuration of general-purpose unit information. FIG. 3 depicts a data structure of general-purpose unit information 76 held in the general-purpose-unit information storage unit 58. The general-purpose unit information 76 includes device information 77. The number of the FA devices represented as one integrated general-purpose unit is held in the device information 77. In other words, the device information 77 is the number of the FA devices that constitute the integrated general-purpose unit.

FIG. 4 depicts a configuration of a screen displayed on a display device of the system design device according to the first embodiment. A screen 72A displayed on the display device 52 of the system design device 50A includes the system-configuration-diagram display unit 73, a unit-component display unit 74, a general-purpose-unit information setting unit 75, and the like.

The system-configuration-diagram display unit 73 is an area that displays a system configuration diagram created by the designer using the calculation unit 62A. The unit-component display unit 74 is an area that displays a list of unit component diagrams of the FA devices, the integrated general-purpose unit, the network cable, and the like that are constituent elements of the system configuration diagram. The general-purpose-unit information setting unit 75 is an area for inputting and setting the number of the FA devices displayed as the integrated general-purpose unit.

The unit component diagrams to be displayed on the unit-component display unit 74 are stored in the unit-component storage unit 69. The display processing unit 61 reads the unit component diagrams from the unit-component storage unit 69 based on a command from the calculation unit 62A and displays them on the unit-component display unit 74. The display processing unit 61 also reads the system configuration diagram from the system-configuration-diagram storage unit 68 and displays it on the system-configuration-diagram display unit 73.

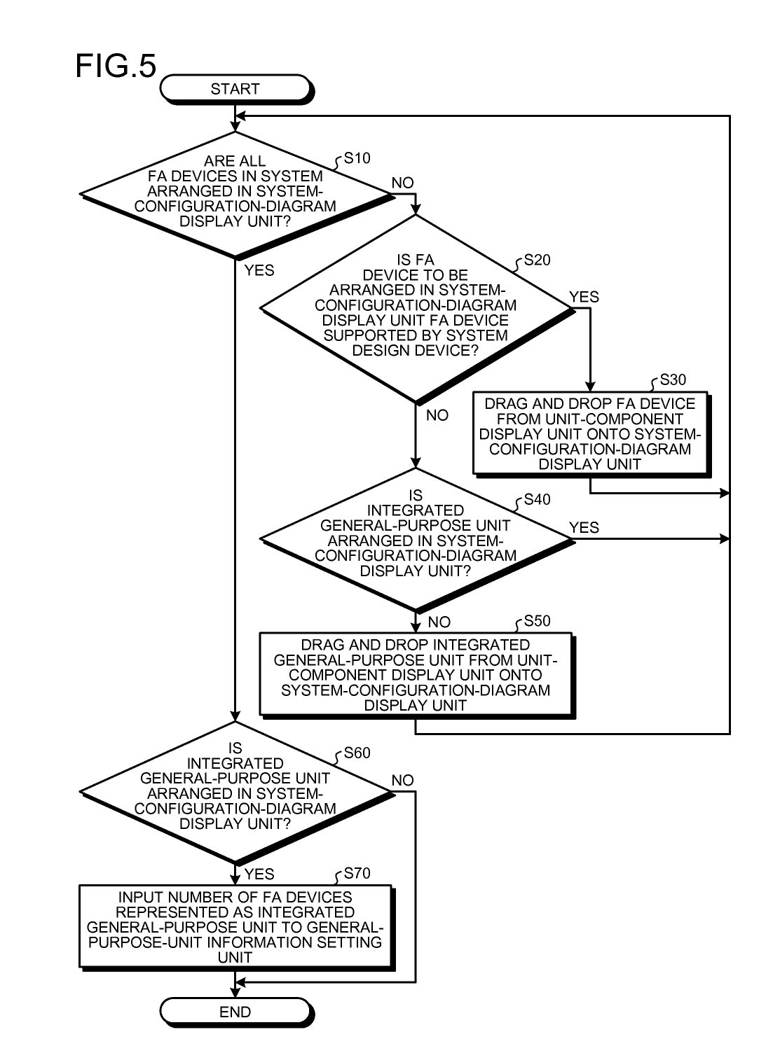

Next, an operation process procedure in the system design device 50A is explained. FIG. 5 is a flowchart of the operation process procedure in the system design device. The system-configuration-diagram creation processing unit 63 in the system design device 50A displays the unit component diagrams on the unit-component display unit 74. Specifically, the system-configuration-diagram creation processing unit 63 transmits the unit component diagrams stored in the unit-component storage unit 69 to the display processing unit 61 and also transmits a command for displaying the unit component diagrams on the unit-component display unit 74 to the display processing unit 61.

Accordingly, the display processing unit 61 displays the unit component diagrams on the unit-component display unit 74.

Thereafter, the system-configuration-diagram creation processing unit 63 determines whether the FA devices that are design targets in the FA system are all arranged in the system-configuration-diagram display unit 73 (Step S10). A designer visually determines whether the FA devices in the FA system are all arranged in the system-configuration-diagram display unit 73, for example. When the FA devices are all arranged, information indicating that the FA devices are all arranged (device arrangement confirmation information) is input to the input device 51 by the designer. The device arrangement confirmation information is input to the system-configuration-diagram creation processing unit 63 through the input processing unit 60. Based on whether the device arrangement confirmation information is input, the system-configuration-diagram creation processing unit 63 determines whether the unit component diagrams are all arranged.

When the unit component diagrams are not all arranged (NO at Step S10), whether the FA device to be arranged in the system-configuration-diagram display unit 73 is an FA device supported by the system design device 50A is determined (Step S20).

When the FA device to be arranged is displayed on the unit-component display unit 74 (YES at Step S20), this FA device to be arranged is determined to be supported by the system design device 50A. The designer visually determines whether the FA device to be arranged in the system-configuration-diagram display unit 73 is displayed on the unit-component display unit 74, for example. When the FA device to be arranged is displayed on the unit-component display unit 74, a diagram representing this FA device to be arranged is dragged and dropped from the unit-component display unit 74 onto the system-configuration-diagram display unit 73 by the designer (Step S30). Accordingly, the system-configuration-diagram creation processing unit 63 creates information concerning the FA device having been dragged and dropped. The diagram showing the FA device is then displayed on the system-configuration-diagram display unit 73.

On the other hand, when the FA device to be arranged is not displayed on the unit-component display unit 74 (NO at Step S20), this FA device to be arranged is determined not to be supported by the system design device 50A. In this case, whether the integrated general-purpose unit has already been arranged in the system-configuration-diagram display unit 73 is determined (Step S40). The designer visually determines whether the integrated general-purpose unit is displayed on the system-configuration-diagram display unit 73, for example. When the integrated general-purpose unit is not displayed on the system-configuration-diagram display unit 73 (NO at Step S40), the integrated general-purpose unit is dragged and dropped from the unit-component display unit 74 onto the system-configuration-diagram display unit 73 (Step S50). Accordingly, the general-purpose-unit creation processing unit 59 creates information concerning the integrated general-purpose unit having been dragged and dropped. The diagram showing the integrated general-purpose unit is then displayed on the system-configuration-diagram display unit 73.

After the diagram representing the FA device to be arranged is dragged and dropped from the unit-component display unit 74 onto the system-configuration-diagram display unit 73 (Step S30), whether the FA devices that are design targets in the FA system are all arranged in the system-configuration-diagram display unit 73 is determined (Step S10).

When the integrated general-purpose unit is displayed on the system-configuration-diagram display unit 73 (YES at Step S40), whether the FA devices that are design targets in the FA system are all arranged in the system-configuration-diagram display unit 73 is determined (Step S10).

After the integrated general-purpose unit is dragged and dropped from the unit-component display unit 74 onto the system-configuration-diagram display unit 73 (Step S50), whether the FA devices that are design targets in the FA system are all arranged in the system-configuration-diagram display unit 73 is determined (Step S10).

In the system design device 50A, processing from Steps S10 to S50 is repeated until the FA devices that are design targets in the FA system are all determined to be arranged in the system-configuration-diagram display unit 73.

When the FA devices that are design targets in the FA system are all determined to be arranged in the system-configuration-diagram display unit 73 (YES at Step S10), whether the integrated general-purpose unit is arranged in the system-configuration-diagram display unit 73 is determined (Step S60). The designer visually determines whether the integrated general-purpose unit is displayed on the system-configuration-diagram display unit 73, for example. When the integrated general-purpose unit is arranged, information indicating that the integrated general-purpose unit is arranged (unit arrangement confirmation information) is input to the input device 51 by the designer. The unit arrangement confirmation information is input to the system-configuration-diagram creation processing unit 63 through the input processing unit 60. Based on whether the unit arrangement confirmation information is input, the system-configuration-diagram creation processing unit 63 determines whether the integrated general-purpose unit is arranged.

When the integrated general-purpose unit is arranged in the system-configuration-diagram display unit 73 (YES at Step S60), the number of the FA devices represented as the integrated general-purpose unit is input to the general-purpose-unit information setting unit 75 by the designer (Step S70). Accordingly, the system-configuration-diagram creation processing unit 63 holds the number of the FA devices represented as the integrated general-purpose unit in the device information 77. Meanwhile, when the integrated general-purpose unit is not arranged in the system-configuration-diagram display unit 73 (NO at Step S60), the processing for creating a system configuration diagram is finished.

The system configuration diagram is displayed on the system-configuration-diagram display unit 73 by the processing for creating a system configuration diagram described above. A plurality of the FA devices that are not supported by the system design device 50A can be displayed as one integrated general-purpose unit on the system configuration diagram by the processing for creating a general-purpose unit. The created integrated general-purpose unit is held in the general-purpose-unit information storage unit 58. The integrated general-purpose unit held in the general-purpose-unit information storage unit 58 is read as needed and displayed on the system-configuration-diagram display unit 73.

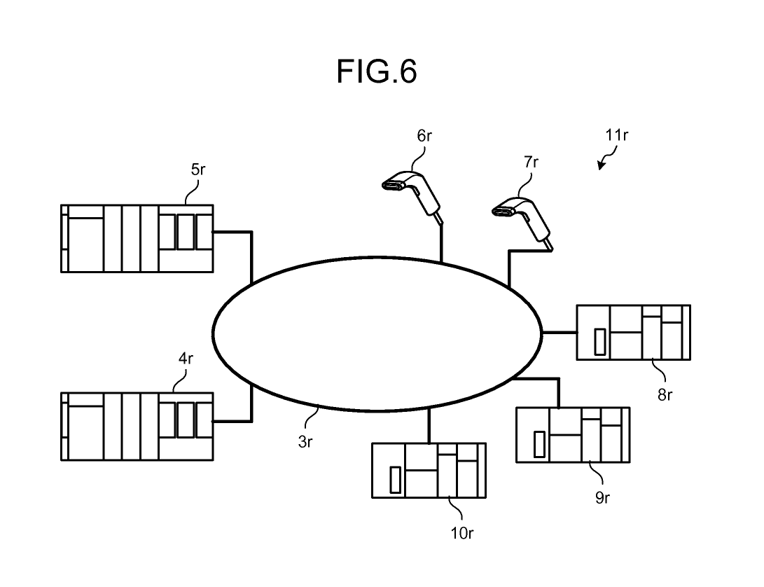

A configuration example of the FA system created by a designer using the system design device 50A is explained. FIG. 6 is a configuration example of the FA system. An FA system 11r shown in FIG. 6 includes a PLC 4r and a PLC 5r that are FA devices supported by the system design device 50A. The FA system 11r also includes a barcode reader 6r, a barcode reader 7r, a PLC 8r, a PLC 9r, and a PLC 10r that are FA devices not supported by the system design device 50A. The PLCs 4r, 5r, 8r, 9r, and 10r and the barcode readers 6r and 7r are connected to an FA network 3r.

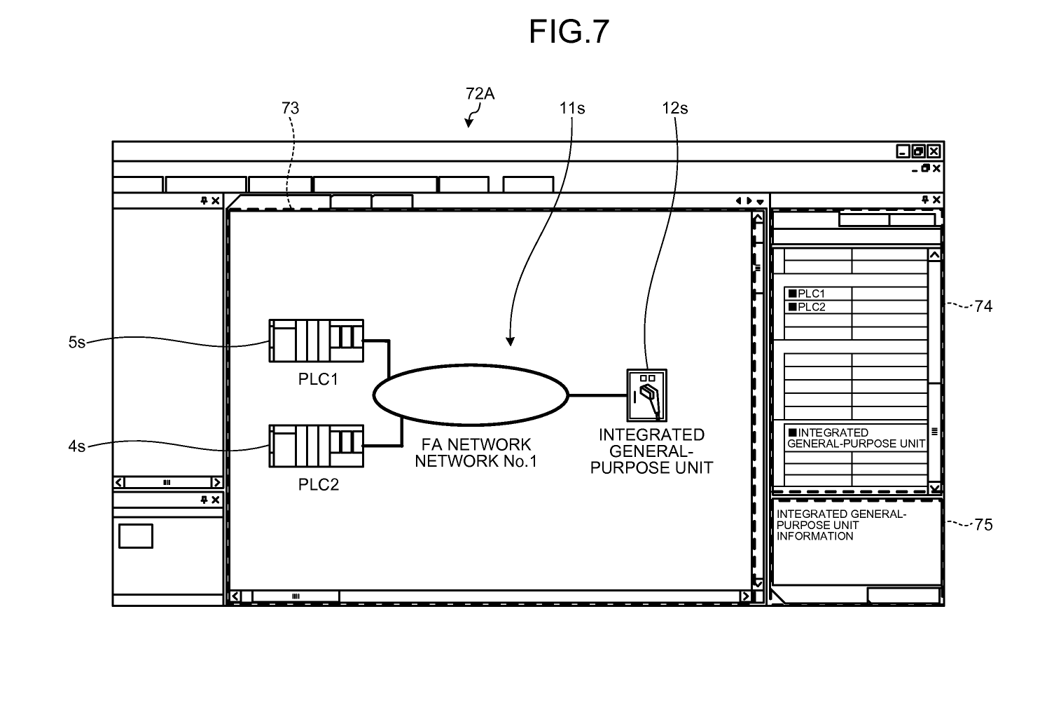

FIG. 7 is an example of a screen displayed on the display device. A system configuration diagram 11s of the FA system 11r shown in FIG. 6 is displayed on the screen 72A. The PLC 4r and the PLC 5r are FA devices supported by the system design device 50A. Therefore, as diagrams showing the PLC 4r (PLC 2) and the PLC 5r (PLC 1), a PLC 4s and a PLC 5s are displayed on the unit-component display unit 74.

When the system configuration diagram 11s of the FA system 11r is created by using the system design device 50A, the PLC 4s and the PLC 5s are dragged and dropped from the unit-component display unit 74 onto the system-configuration-diagram display unit 73 by the designer. Accordingly, the PLC 5s and the PLC 4s are displayed respectively as a first PLC1 and a second PLC2 on the system-configuration-diagram display unit 73.

Meanwhile, the barcode readers 6r and 7r and the PLCs 8r to 10r are FA devices that are not supported by the system design device 50A. Therefore, diagrams showing the barcode readers 6r and 7r and the PLCs 8r to 10r are not displayed on the unit-component display unit 74. In a case where unit component diagrams are not displayed on the unit-component display unit 74 or where unit component diagrams are not design targets, one diagram representing the integrated general-purpose unit is dragged and dropped from the unit-component display unit 74 onto the system-configuration-diagram display unit 73 by the designer. Accordingly, as a diagram showing the integrated general-purpose unit, an integrated general-purpose unit 12s is displayed on the system-configuration-diagram display unit 73.

Consequently, as a diagram showing the FA network 3r, the system configuration diagram 11s in which the PLCs 4s and 5s and the integrated general-purpose unit 12s are connected is displayed on the system-configuration-diagram display unit 73.

Furthermore, the number of the FA devices represented as the integrated general-purpose unit 12s is input to the general-purpose-unit information setting unit 75 by the designer. The integrated general-purpose unit 12s corresponds to the five FA devices in total which are the barcode readers 6r and 7r and the PLCs 8r to 10r. Therefore, the number of the FA devices in the integrated general-purpose unit 12s, “5” is input to the general-purpose-unit information setting unit 75.

A conventional system design device needs to create five general-purpose units in the system-configuration-diagram display unit 73 in order to represent the five FA devices that are the barcode readers 6r and 7r and the PLCs 8r to 10r. On the other hand, it suffices that the system design device 50A according to the present embodiment creates one integrated general-purpose unit in the system-configuration-diagram display unit 73 in order to represent the above five FA devices.

System design of the FA system is performed by each device manufacturer. However, unless FA devices (units) outside of its allocated design range are correctly arranged, duplicate network station numbers assigned to the FA devices cannot be checked for. In the present embodiment, a plurality of the FA devices are replaced with one integrated general-purpose unit, thereby eliminating the need to know details of the FA devices outside of the design range. This saves time and effort to create a system configuration diagram.

As described above, according to the first embodiment, in a case where there are a plurality of FA devices outside of the allocated design range and FA devices that are not supported by the system design device 50A, these FA devices are represented as one integrated general-purpose unit on a system configuration diagram. Accordingly, the designer does not need to create general-purpose units on the system configuration diagram by the number of the FA devices outside of the allocated design range and the devices that are not supported by the system design device 50A. Therefore, it is possible to easily create the system configuration diagram.

### Second Embodiment

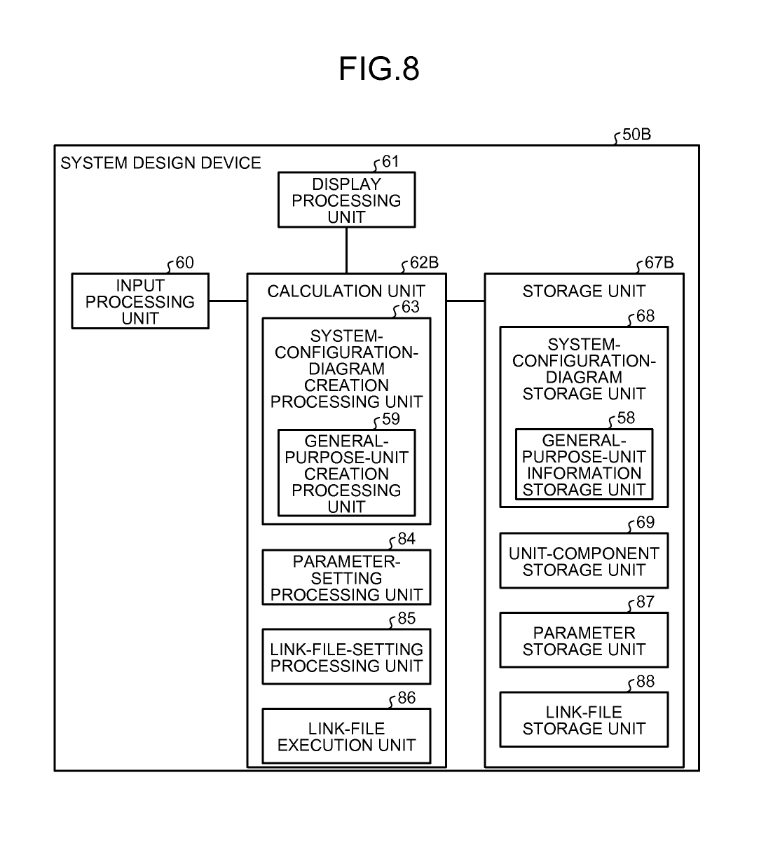

Next, a second embodiment of the present invention is explained with reference to FIGS. 8 to 14. In the second embodiment, a parameter such as a station number is set to each of FA devices that constitute an integrated general-purpose unit. Further, a link file is set to each of the FA devices that constitute the integrated general-purpose unit.

FIG. 8 is a functional block diagram of a system design device according to the second embodiment. Among respective constituent elements shown in FIG. 8, those realizing the same functions as the constituent elements of the system design device 50A shown in FIG. 2 are denoted by like reference signs and redundant explanations thereof will be omitted.

Because a hardware configuration of a system design device 50B according to the second embodiment is the same as the hardware configuration of the system design device 50A explained in the first embodiment, descriptions thereof are omitted. A system design program executed by the system design device 50B has a module configuration including the system-configuration-diagram creation processing unit 63, a parameter-setting processing unit 84, a link-file-setting processing unit 85, and a link-file execution unit 86 that are described later. These units are loaded on a main storage device and generated on the main storage device.

The system design device 50B starts software (the system design program) having been installed therein in advance, thereby creating a system configuration diagram, setting a parameter to an FA device in an FA system, and setting a link file.

The system design device 50B includes the input processing unit 60, the display processing unit 61, a calculation unit 62B, and a storage unit 67B. The calculation unit 62B has the same function as the calculation unit 62A. The storage unit 67B has the same function as the storage unit 67A.

The calculation unit 62B includes the system-configuration-diagram creation processing unit 63, the parameter-setting processing unit 84, the link-file setting processing unit 85, and the link-file execution unit 86. The storage unit 67B includes the system-configuration-diagram storage unit 68, the unit-component storage unit 69, a parameter storage unit 87, and a link-file storage unit 88.

The parameter-setting processing unit 84 sets a parameter to an FA device that constitutes a system configuration diagram. The parameter-setting processing unit 84 stores a parameter of the FA device and a parameter of the integrated general-purpose unit, which are input by a designer, in the parameter storage unit 87.

The link-file-setting processing unit 85 sets an external tool that is not included in a product as a link file. For example, the link file is a file executed by an application other than that of the system design device 50B. The link-file-setting processing unit 85 stores a link file input by the designer in the link-file storage unit 88. The link-file execution unit 86 reads the link file from the link-file storage unit 88 and executes the link file.

The parameter storage unit 87 stores therein the parameter of the FA device and the parameter of the integrated general-purpose unit, which are input by the designer. The link-file storage unit 88 stores therein the link file input by the designer.

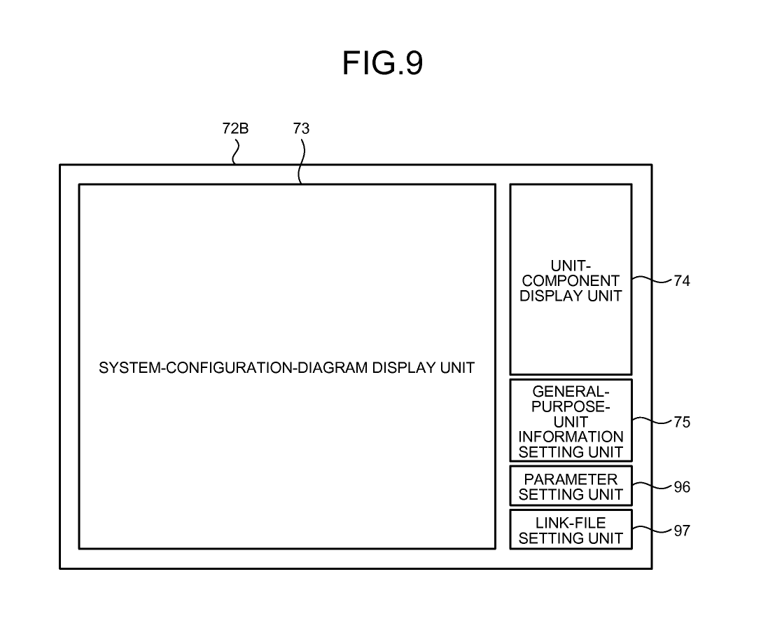

FIG. 9 depicts a configuration of a screen displayed on a display device of the system design device according to the second embodiment. A screen 72B displayed on the display device 52 of the system design device 50B includes the system-configuration-diagram display unit 73, the unit-component display unit 74, the general-purpose-unit information setting unit 75, a parameter setting unit 96, a link-file setting unit 97, and the like.

The parameter setting unit 96 is an area for inputting and setting a parameter to an FA device that constitutes a system configuration diagram. The link-file setting unit 97 is an area for inputting and setting a link file.

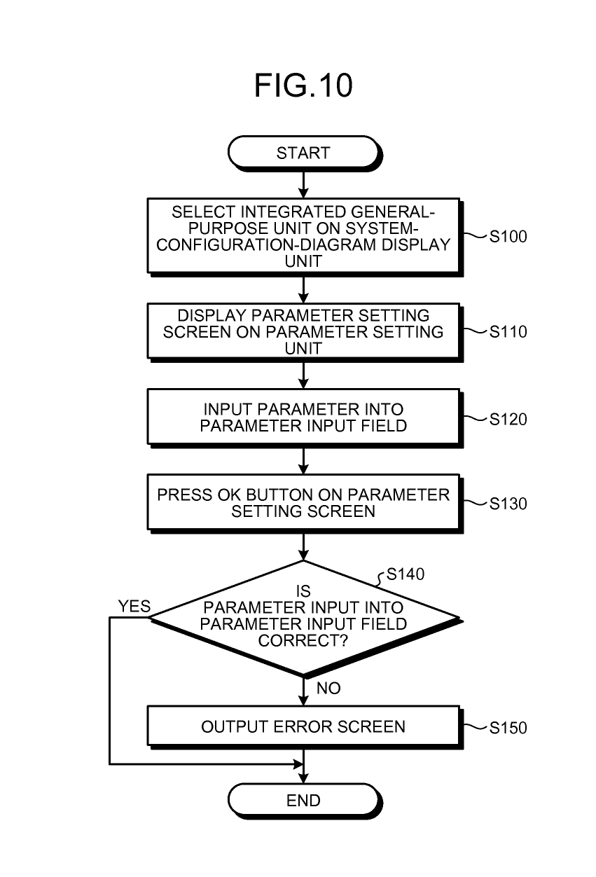

FIG. 10 is a flowchart of a parameter-setting process procedure. When a parameter is set to an FA device that constitutes a system configuration diagram, the system configuration diagram is displayed on the system-configuration-diagram display unit 73. Thereafter, the integrated general-purpose unit 12s displayed on the system-configuration-diagram display unit 73 is selected by a designer. The integrated general-purpose unit 12s is selected by the designer using a mouse or the like (the input device 51) (Step S100).

When the integrated general-purpose unit 12s is selected, the parameter-setting processing unit 84 displays a parameter setting screen corresponding to the integrated general-purpose unit 12s on the parameter setting unit 96 (Step S110).

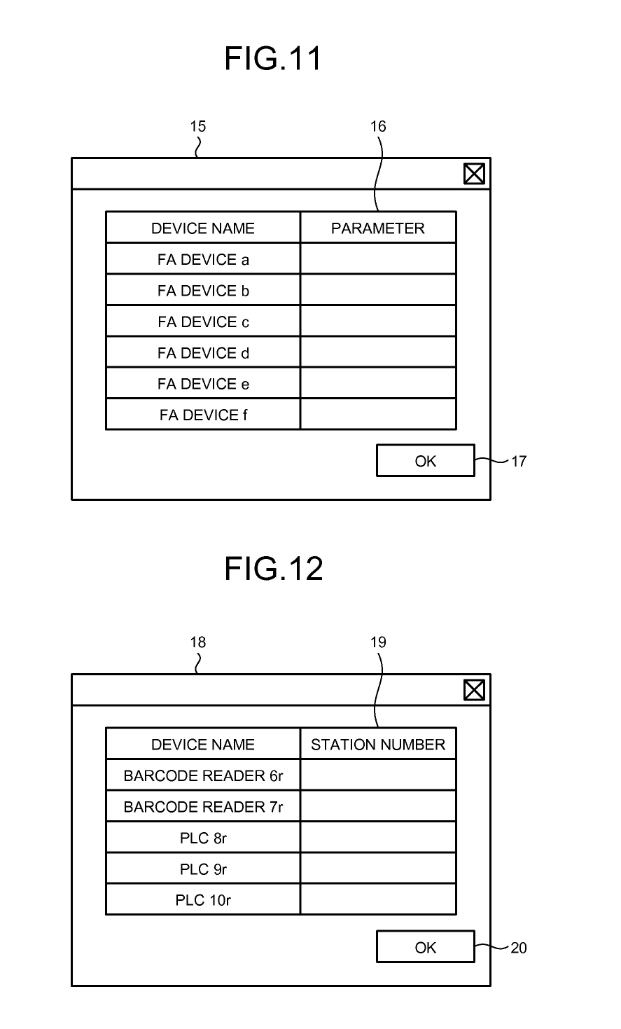

FIG. 11 is an example of the parameter setting screen. A parameter setting screen 15 is a screen for inputting and setting a correspondence relationship between a “device name” of each of FA devices that constitute the integrated general-purpose unit 12s and a “parameter” of each of the FA devices. A parameter input field 16 that is a field to input the “parameter” and an OK button 17 that commands to finish the parameter input are arranged in the parameter setting screen 15.

FIG. 11 depicts a case where the “device names” of the FA devices that constitute the integrated general-purpose unit 12s are an FA device “a” to an FA device “f,” respectively. The “parameters” corresponding to the respective FA devices “a” to “f” are input for the FA devices “a” to “f” by a designer. Specifically, the parameters of the respective FA devices “a” to “f” are input into the parameter input field 16 (Step S120).

After the parameters of the respective FA devices “a” to “f” are input, the OK button 17 on the parameter setting screen 15 is pressed by the designer (Step S130). Accordingly, the parameter input processing is finished. Thereafter, the parameter-setting processing unit 84 determines whether the parameter input into the parameter input field 16 is a correct parameter (Step S140).

When the parameter input into the parameter input field 16 is determined to be incorrect (NO at Step S140), the parameter-setting processing unit 84 notifies the designer that the incorrect parameter is input. Specifically, the parameter-setting processing unit 84 outputs an error screen (a dialog) indicating that the incorrect parameter is input to the display processing unit 61 (Step S150). Accordingly, the error screen indicating that the incorrect parameter is input is displayed on the system-configuration-diagram display unit 73 or the parameter setting unit 96. The device name and the like of the FA device in which the incorrect parameter is input are displayed on the error screen. The parameter-setting processing unit 84 stores the parameter of the FA device and the parameter of the integrated general-purpose unit, which are input by the designer, in the parameter storage unit 87.

Next, parameter setting processing in a case where a parameter is set to an FA device that constitutes the FA system 11r shown in FIG. 6 is explained. In the present embodiment, a case where the parameter set to the FA device is a station number (a network station number) is explained. The parameter set to the FA device can be any kind of parameter other than the station number. For example, the parameter set to the FA device can be an Internet protocol (IP) address of the FA device or a media access control (MAC) address of the FA device.

The system design device 50B creates the system configuration diagram 11s of the FA system 11r. The barcode readers 6r and 7r and the PLCs 8r to 10r that are FA devices not supported by the system design device 50B are represented as the integrated general-purpose unit 12s in the system configuration diagram 11s.

When a designer uses the input device 51 such as a mouse to select the integrated general-purpose unit 12s, a parameter setting screen 18 shown in FIG. 12 is displayed on the parameter setting unit 96. The parameter setting screen 18 is an example of the parameter setting screen 15. The parameter setting screen 18 is a screen for inputting and setting a correspondence relationship between a “device name” of each of FA devices that constitute the integrated general-purpose unit 12s and a “station number” that is an example of the parameter of each of the FA devices. A station-number input field 19 that is a field to input the “station number” and an OK button 20 that commands to finish the station-number input are arranged in the parameter setting screen 18.

As the “device name” of each of the FA devices, the barcode readers 6r and 7r and the PLCs 8r to 10r that constitute the integrated general-purpose unit are displayed on the parameter setting screen 18. The “station numbers” corresponding to the barcode readers 6r and 7r and the PLCs 8r to 10r are input respectively for the barcode readers 6r and 7r and the PLCs 8r to 10r by the designer. Specifically, the station numbers of the barcode readers 6r and 7r and the PLCs 8r to 10r are input respectively into the station-number input field 19. After the station numbers are input, the OK button 20 is pressed by the designer to finish the station-number input processing.

Thereafter, the calculation unit 62B checks a list and a range of the station numbers based on information set by the system-configuration-diagram creation processing unit 63. The calculation unit 62B also reflects the information set by the system-configuration-diagram creation processing unit 63 on each project.

A conventional system design device needs to set the station numbers respectively to the barcode readers 6r and 7r and the PLCs 8r to 10r by individually opening the parameter setting screen 18. On the other hand, in the present embodiment, it is possible to set all the station numbers at once by opening the parameter setting screen of one integrated general-purpose unit representing the barcode readers 6r and 7r and the PLCs 8r to 10r.

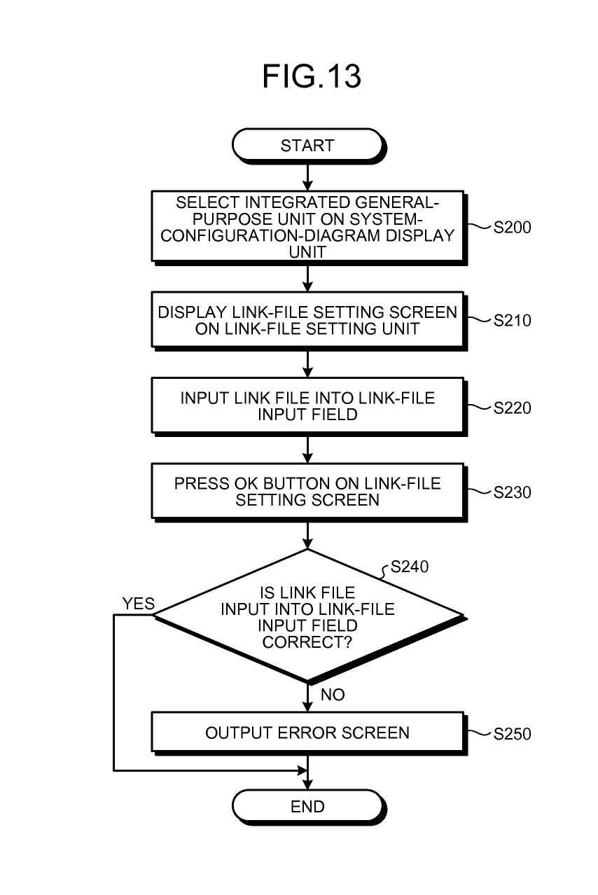

FIG. 13 is a flowchart of a link-file-setting process procedure. When a link file is set to an FA device that constitutes a system configuration diagram, the system configuration diagram is displayed on the system-configuration-diagram display unit 73. Thereafter, the integrated general-purpose unit 12s displayed on the system-configuration-diagram display unit 73 is selected by a designer. The integrated general-purpose unit 12s is selected by the designer using a mouse or the like (the input device 51) (Step S200).

When the integrated general-purpose unit 12s is selected, the link-file-setting processing unit 85 displays a link-file setting screen corresponding to the integrated general-purpose unit 12s on the link-file setting unit 97 (Step S210).

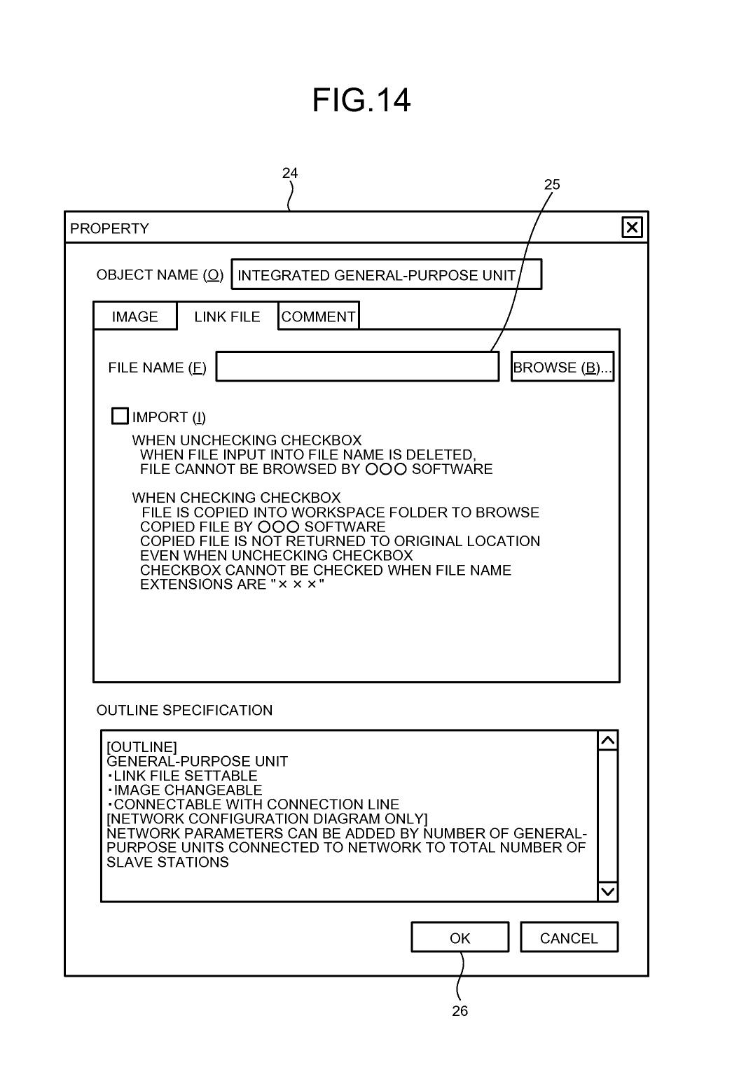

FIG. 14 is an example of the link-file setting screen. A link-file setting screen 24 is a screen for inputting and setting a link file and the like of the integrated general-purpose unit 12s. A link-file input field 25 that has a file name (a path) of a link file input therein and an OK button 26 that commands to finish link-file setting are arranged in the link-file setting screen 24.

The link file is input into the link-file input field 25 by a designer. Specifically, the path in which the link file of the integrated general-purpose unit 12s is stored is input into the link-file input field 25 (Step S220).

After the link file is input, the OK button 26 on the link-file setting screen 24 is pressed by the designer (Step S230). Accordingly, the link-file input processing is finished.

Thereafter, the link-file-setting processing unit 85 determines whether the link file input into the link-file input field 25 is a correct link file (Step S240). Specifically, the link-file-setting processing unit 85 determines whether the link file exists in the path input into the link-file input field 25. The link-file-setting processing unit 85 also determines whether a character, which is defined as a prohibited character by the system design device 50B, is included in the path input into the link-file input field 25, for example.

When an incorrect path is determined to be input into the link-file input field 25 (NO at Step S240), the link-file-setting processing unit 85 notifies the designer of contents of the error. Specifically, the link-file-setting processing unit 85 outputs an error screen (a dialog) indicating that the incorrect path is input to the display processing unit 61. Accordingly, the error screen indicating that the incorrect path is input is displayed on the system-configuration-diagram display unit 73 or the link-file setting unit 97 (Step S250).

An operation of the system design device 50B in a case where a link file is set to the integrated general-purpose unit 12s is explained. A case where a manual file of the FA device displayed as the integrated general-purpose unit is set as a link file is explained. The system design device 50B creates the system configuration diagram 11s of the FA system 11r. When the designer uses the input device 51 such as a mouse to select the integrated general-purpose unit 12s on the system configuration diagram 11s, the link-file setting screen 24 is displayed on the link-file setting unit 97.

A path in which the manual file is stored is input into the link-file input field 25 on the link-file setting screen 24, and the OK button 26 is pressed. Accordingly, the manual file can be set as a link file to the integrated general-purpose unit 12s.

The link file set to the integrated general-purpose unit 12s is held in the link-file storage unit 88. The link file set to the integrated general-purpose unit 12s is executed by double-clicking the integrated general-purpose unit 12s on the system configuration diagram 11s, for example. In the present embodiment, the manual file is started as a link file. Specifically, the link-file execution unit 86 reads the manual file from the link-file storage unit 88 and transmits it to the display processing unit 61. Accordingly, contents of the manual file are displayed on the system-configuration-diagram display unit 73 and the like.

As described above, the external tool that is not included in a product is set to the integrated general-purpose unit 12s in the system configuration diagram 11s. Therefore, there is no need to determine what the necessary external tool is when software is started.

While a case where one link file is set to the integrated general-purpose unit 12s has been explained in the present embodiment, a plurality of link files can be set to the integrated general-purpose unit 12s.

As described above, according to the second embodiment, it is possible to set parameters to an FA system outside of the allocated design range and to a plurality of FA devices that are not supported by the system design device 50B all at once through parameter setting processing on one integrated general-purpose unit. Accordingly, the designer does not need to set parameters by the number of the FA devices outside of the allocated design range and the FA devices that are not supported by the system design device 50A.

Further, because a link file can be set to the integrated general-purpose unit, it is possible to execute the link file having been set by an external application by only double-clicking the integrated general-purpose unit on an FA system configuration diagram. Therefore, a burden of system design processing on a designer can be reduced. Further, it is possible to easily check for duplicate parameters such as duplicate station numbers.

### INDUSTRIAL APPLICABILITY

As described above, the system design device according to the present invention is suitable for designing an FA system that is constituted by FA devices.

### REFERENCE SIGNS LIST

3r FA network
6r, 7r barcode reader
11r FA system
11s system configuration diagram
12s integrated general-purpose unit
15, 18 parameter setting screen
16 parameter input field
19 station-number input field
24 link-file setting screen
25 link-file input field
50A, 50B system design device
51 input device
52 display device
53 central calculation device
54 storage device
58 general-purpose-unit information storage unit
59 general-purpose-unit creation processing unit
62A, 62B calculation unit
63 system-configuration-diagram creation unit
67A, 67B storage unit
68 system-configuration-diagram storage unit
69 unit-component storage unit
72A, 72B screen
73 system-configuration-diagram display unit
84 parameter-setting processing unit
85 link-file-setting processing unit
86 link-file execution unit
87 parameter storage unit
88 link-file storage unit
96 parameter setting unit
97 link-file setting unit

1. A system design device comprising:
a storage unit that stores therein configuration diagrams of FA devices designed by the device itself among FA devices that are constituent elements of an FA system as design-target-unit configuration diagrams and stores therein configuration diagrams of a plurality of FA devices that are not designed by the device itself among the FA devices as a general-purpose-unit configuration diagram that is one configuration diagram;
an input unit that has input thereto command information for specifying at least one of the design-target-unit configuration diagrams and the general-purpose-unit configuration diagram;
a system-configuration-diagram creation unit that reads a design-target-unit configuration diagram and a general-purpose-unit configuration diagram from the storage unit according to command information input from the input unit and creates a system configuration diagram of the FA system; and
a display unit that displays a system configuration diagram created by the system-configuration-diagram creation unit, thereby displaying a plurality of FA devices that are not designed by the device itself among the FA devices as a general-purpose-unit configuration diagram that is one configuration diagram.

2. The system design device according to claim 1, wherein
a parameter set to each of FA devices that constitute the general-purpose-unit configuration diagram is input to the input unit for each of the FA devices, and
the system design device further comprises a parameter setting unit that stores a parameter input from the input unit in the storage unit corresponding to each of FA devices that constitute the general-purpose-unit configuration diagram.

3. The system design device according to claim 1, wherein
a link file set to each of FA devices that constitute the general-purpose-unit configuration diagram and executed by an application other than that of the device itself is input to the input unit for each of the FA devices, and
the system design device further comprises a link-file setting unit that stores a link file input from the input unit in the storage unit corresponding to each of FA devices that constitute the general-purpose-unit configuration diagram.

4. The system design device according to claim 2, wherein
number of FA devices that constitute the general-purpose-unit configuration diagram is input to the input unit, and
the parameter setting unit displays parameter input fields in a same number as the number of the FA devices on the display unit.
